(19) United States
(12) Patent Application Publication
(10) Pub. No.: US 2025/0263313 A1
(43) Pub. Date: Aug. 21, 2025

(54) METHOD FOR PRODUCING ULTRAPURE WATER, ULTRAPURE WATER PRODUCTION APPARATUS, AND ULTRAPURE WATER PRODUCTION SYSTEM

(71) Applicant: Nomura Micro Science Co., Ltd., Atsugi-Shi (JP)

(72) Inventors: Masamitsu IIYAMA, Atsugi-Shi (JP); Hiroki MIYAZAWA, Atsugi-Shi (JP); Toru AMAYA, Atsugi-Shi (JP)

(73) Assignee: Nomura Micro Science Co., Ltd., Atsugi-Shi (JP)

(21) Appl. No.: 18/825,042

(22) Filed: Sep. 5, 2024

(30) Foreign Application Priority Data
Feb. 20, 2024 (JP) 2024-024056
Jun. 27, 2024 (JP) 2024-103650

(51) Int. Cl. C02F 1/44; B01D 61/14; B01D 61/16; C02F 1/42; C02F 101/20; C02F 103/04

(52) U.S. Cl. CPC C02F 1/444; B01D 61/145; B01D 61/16; C02F 1/42; B01D 2311/04; B01D 2313/243; C02F 2001/427; C02F 2101/203; C02F 2103/04; C02F 2201/006

(57) ABSTRACT

In the method for producing ultrapure water including filtration through a filtration membrane, the filtration membrane is one or more selected from an UF, a MF and an ion exchange membrane, and the filtration is performed under conditions satisfying both (1) and (2). (1) A permeate water flux at the time of filtration is within a range from equal to or more than 0.5 times to equal to or less than 2.0 times of an optimum permeate water flux determined according to intermembrane differential pressure/permeate water flux in the filtration membrane. (2) A water recovery rate in the filtration is equal to or more than 50% and less than 80%.

### FIELD

The present invention relates to a method for producing ultrapure water, an ultrapure water production apparatus, and an ultrapure water production system. In particular, the present invention relates to a method for producing ultrapure water, an ultrapure water production apparatus, and an ultrapure water production system that can reduce iron concentration and silica concentration in ultrapure water.

### BACKGROUND

Ultrapure water used in semiconductor manufacturing processes and the like is produced by an ultrapure water production system including a primary pure water apparatus and a secondary pure water apparatus in this order. In the ultrapure water production system, the primary pure water apparatus produces primary pure water by removing total organic carbon (TOC) components or ionic components in raw water or pretreated water using a reverse osmosis membrane device or an ion exchange device. The secondary pure water apparatus produces ultrapure water by removing a trace amount of impurities in the primary pure water. Typically, a cross-flow ultrafiltration membrane (UF) device is provided at the end of the secondary pure water apparatus, and the device is operated with a water recovery rate of equal to or more than 90% and equal to or less than 99%, thereby removing nanometer size microparticles.

In the ultrapure water production system, various attempts have been conducted for highly removing impurities such as microparticles in water to improve purity. Examples of such attempts include: a method of filtering the total amount of water with a cationic functional group-containing membrane for removing microparticles at the end of the secondary pure water apparatus (see, for example, Patent Literature 1); a method of arranging multiple stage ultrafiltration membrane devices in series at the end (see, for example, Patent Literature 2); and a method of providing liquid feeding pumps for feeding pure water to the secondary pure water apparatus in parallel, thereby operating the pumps with low output all the time (see, for example, Patent Literature 3). Furthermore, an apparatus including a porous ion exchanger and microfiltration membrane device in this order at the downstream side of the ultrafiltration membrane device of the secondary pure water apparatus has also been proposed (see, for example, Patent Literature 4).

### PATENT LITERATURE

Patent Literature 1: JP-A-2017-170406
Patent Literature 2: JP-A-2016-064342
Patent Literature 3: JP-A-2006-167661
Patent Literature 4: JP-A-2022-154537

### SUMMARY

In recent years, water quality required for ultrapure water used in semiconductor manufacturing processes has become increasingly severe along with significant progress of miniaturization and high integration of semiconductor circuits. For example, according to International Technology Roadmap for Semiconductors (ITRS), the number of microparticles with a particle diameter equal to or more than 10 nm contained in ultrapure water is required to be controlled to equal to or less than 1 microparticle/ml. However, the technologies disclosed in Patent Literatures 1 to 4 cannot necessarily provide such treated water quality meeting the above demand. For example, remained iron or silica in treated water of a polisher (non-regenerative mixed bed ion exchange resin device) provided at the preceding stage of the ultrafiltration membrane device may lead to an increase of the number of microparticles in ultrapure water. Such problem was made clear through detailed examination by the present inventors. In particular, it was also found that when a booster pump or heat exchanger is provided at near the end of the secondary pure water apparatus, the number of microparticles (including colloids of Fe, Cr, Si, and the like) tends to increase. Whereas, generation of microparticles from e.g. a gasket of connection parts of each device has also become highlighted as a problem. Furthermore, in the ultrafiltration membrane device, examination has been conventionally made to decrease the molecular weight cut-off for removing even smaller microparticles. However, there has been a problem that even when the molecular weight cut-off decreased, improvement of microparticle removing capacity is slight, and water production is decreased.

The present invention was made to solve the problem described above, and has for its object to provide a method for producing ultrapure water, an ultrapure water production apparatus, and an ultrapure water production system that can sufficiently reduce the number of microparticles such as iron and silica in ultrapure water without significant reduction of water production with no use of complicated equipment.

The method for producing ultrapure water, ultrapure water production apparatus, and ultrapure water production system according to an embodiment of the present invention is described in the following.
[I]A method for producing ultrapure water including filtration through a filtration membrane,
   wherein the filtration membrane is one or more selected from an ultrafiltration membrane (UF), a micro membrane (MF), and an ion exchange membrane, and the filtration is performed under conditions satisfying both (1) and (2) below:
   (1) a permeate water flux at the time of filtration is within a range from equal to or more than 0.5 times to equal to or less than 2.0 times of an optimum permeate water flux determined according to intermembrane differential pressure/permeate water flux in the filtration membrane; and
   (2) a water recovery rate in the filtration is equal to or more than 50% and less than 80%.
The method for producing ultrapure water as recited in [I], wherein water to be subjected to the filtration has a resistivity equal to or more than 17 MΩ·cm, an iron concentration of 3 ng/L to 100 ng/L, and a silica concentration of 10 to 1000 ng/L.
[III] The method for producing ultrapure water as recited in [I] or [II], wherein treated water of a non-regenerative mixed bed ion exchange resin device is used as water to be subjected to the filtration.
[IV] The method for producing ultrapure water as recited in any one of [I] to [III], including treating raw water with a primary pure water apparatus and a secondary pure water apparatus in this order,
   wherein the filtration is performed at an end of the secondary pure water apparatus.
[V] The method as recited in any one of [I] to [IV], wherein the ultrapure water produced by the method has an iron concentration equal to or less than 1 ng/L, and a silica concentration equal to or less than 20 ng/L.
[VI] An ultrapure water production apparatus including a filtration membrane module having a filtration membrane,
   wherein the filtration membrane is one or more selected from an ultrafiltration membrane, a microfiltration membrane, and an ion exchange membrane,
   and filtration in the filtration membrane module is controlled to conditions satisfying both (1) and (2) below:
   (1) a permeate water flux of the filtration membrane module is within a range from equal to or more than 0.5 times to equal to or less than 2.0 times of an optimum permeate water flux determined according to intermembrane differential pressure/permeate water flux in the filtration membrane module; and
   (2) a water recovery rate in the filtration membrane module is equal to or more than 50% and less than 80%.
[VII] The ultrapure water production apparatus as recited in [VI], including a water feed pump, a non-regenerative mixed bed ion exchange resin device, and the ultrafiltration membrane module in this order.
[VIII] The ultrapure water production apparatus as recited in [VI] or [VII], wherein water to be treated that is supplied to the filtration membrane module has a resistivity equal to or more than 17 MΩ·cm, an iron concentration equal to or more than 3 ng/L, and a silica concentration equal to or more than 100 ng/L.
[IX] An ultrapure water production system, including: a primary pure water apparatus for producing primary pure water by treating raw water; and a secondary pure water apparatus for treating the primary pure water,
   wherein the ultrafiltration membrane module as recited in any one of [VI] to [VIII] is included at an end of the secondary pure water apparatus.

Note that when a numerical range is recited herein using “to”, the numerical values before and after “to” are also included in the range.

In accordance with the method for producing ultrapure water, ultrapure water production apparatus, and ultrapure water production system of the present invention, the number of microparticles such as iron and silica in ultrapure water can be sufficiently reduced without significant reduction of water production with no use of complicated equipment.

### BRIEF DESCRIPTION OF DRAWINGS

FIG. 1 is a block diagram schematically showing the configuration of an ultrapure water production apparatus used for the method for producing ultrapure water according to an embodiment;

FIG. 2 is a diagram for describing states of microparticles trapped on a filtration membrane in filtration through the membrane according to the present embodiment, schematically showing, from the above, (a) initial stage of filtration, (b) stage at which the filtration proceeds, and (c) stage at which the filtration further proceeds;

FIG. 3 is a block diagram schematically showing the configuration of a filtration membrane device in a secondary pure water apparatus of a first variant example;

FIG. 4 is a block diagram schematically showing a secondary pure water apparatus according to a second variant example;

FIG. 5 is a block diagram schematically showing an ultrapure water production system according to an embodiment;

FIG. 6 is a block diagram schematically showing the secondary pure water apparatus used in Examples;

FIG. 7 is a graph for obtaining an optimum permeate water flux; and

FIG. 8 is a graph showing the relation between water recovery rate and iron removal rate when the permeate water flux is changed.

### DETAILED DESCRIPTION

Hereinafter, embodiments of the present invention will be described. The method for producing ultrapure water according to the embodiment is a method for reducing iron and silica in ultrapure water by performing filtration under predetermined conditions in a method for producing ultrapure water including filtration through a filtration membrane. The filtration membrane is one or more selected from an ultrafiltration membrane (UF), a micro membrane (MF), and an ion exchange membrane. In the following, a case of using the ultrafiltration membrane as a filtration membrane is described. A case of using the microfiltration membrane (MF) or the ion exchange membrane is also the same.

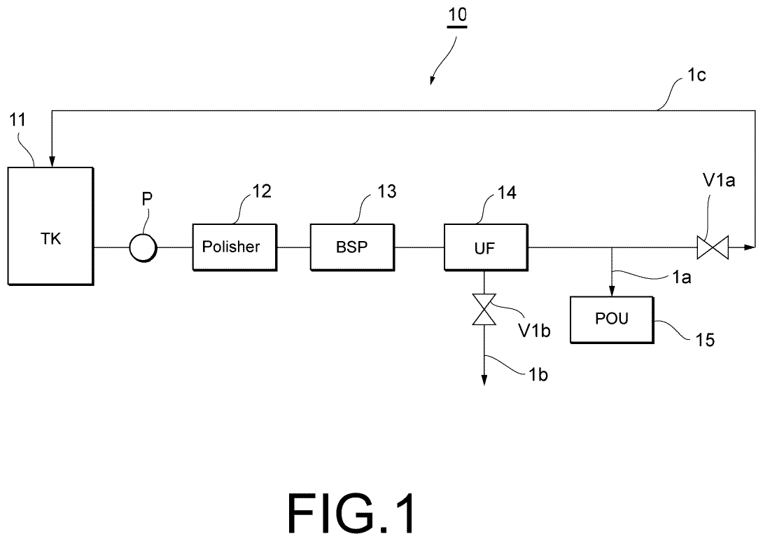

FIG. 1 is a block diagram schematically showing the configuration of a secondary pure water apparatus 10 used for the method for producing ultrapure water according to the embodiment. The secondary pure water apparatus 10 shown in FIG. 1 is an apparatus for producing ultrapure water. A pure water tank (TK) 11, a water feed pump P provided at the subsequent stage of the pure water tank 11, a non-regenerative mixed bed ion exchange resin device (Polisher) 12, a booster pump (BSP) 13, and an ultrafiltration membrane device (UF) 14 are included in this order. In the secondary pure water apparatus 10, pure water (primary pure water) stored in the tank 11 is supplied to a non-regenerative mixed bed ion exchange resin device 12 and an ultrafiltration membrane device 14 by the water feed pump P, and treated in sequence to produce ultrapure water.

In the secondary pure water apparatus 10, the permeation side of the ultrafiltration membrane device 14 is connected to a point of use (POU) 15 via a water feed pipe 1a. The ultrapure water produced by the secondary pure water apparatus 10 is transferred to the point of use (POU) 15 via the water feed pipe 1a, and used in this point. One end of a circulation pipe 1c is branched and connected to the water feed pipe 1a. A valve V1a is provided in the path of the circulation pipe 1c. A drain pipe 1b is connected to the concentration side of the ultrafiltration membrane device 14, and a valve V1b is provided in the path of the drain pipe 1b. The other end of the circulation pipe 1c is connected to the tank 11. Ultrapure water that has not been used in the point of use 15 is returned to the tank 11 by these configurations.

The ultrafiltration membrane device 14 includes one or more ultrafiltration membrane modules, or one or more ultrafiltration membrane cartridges. The ultrafiltration membrane module includes an ultrafiltration membrane within a housing having a water inlet for water supply, a discharge port of permeate water, and a discharge port of concentrated water. The configuration is such that water to be treated is made to flow through the ultrafiltration membrane by connecting each opening of the module to the pipe. The ultrafiltration membrane module has an advantage that, when clogging of the ultrafiltration membrane proceeds and thereby filtration performance is degraded, the whole module can be replaced so that the degraded ultrafiltration membrane can be washed by each module. The ultrafiltration membrane placed in the ultrafiltration membrane module may also be called an ultrafiltration membrane cartridge. In the case of using the ultrafiltration membrane cartridge, only a cartridge within the ultrafiltration membrane module can be replaced. In the present embodiment, the ultrafiltration membrane device 14 including one ultrafiltration membrane module is described as an example. In the ultrafiltration membrane device 14 including one ultrafiltration membrane module, water flow conditions are the same in the ultrafiltration membrane device 14 and the ultrafiltration membrane module.

In FIG. 1, only one point of use 15 is shown, but the pure water production apparatus 10 may be connected to two or more points of use 15. In such case, branch pipes may be provided in the circulation pipe 1c for connecting to each point of use, and thereby ultrapure water can be supplied to each point of use via the branch pipes.

Next, a method for producing ultrapure water according to an embodiment using the secondary pure water apparatus 10 is described. At first, the water feed pump P operates, and thereby pure water in the pure water tank 11 is fed to the subsequent stage. The material, shape, or the like of the pure water tank 11 is not particularly limited as long as rust or the like is not generated, component elution from the container hardly occurs, and primary pure water can be stably stored. For example, the material of the pure water tank 11 is preferably a fiber-reinforced plastic (FRP), polyethylene, SUS304, or a material lined with a fluororesin, such as Teflon (registered trademark). The upper part of the pure water tank 11 is preferably purged with an inert gas such as pure nitrogen for preventing absorption of impurity gases such as carbonic acid gas and dissolved oxygen. Among produced ultrapure water, when unused ultrapure water is circulated, the pure water tank 11 may store a mixture of the above primary pure water and ultrapure water.

Pure water (primary pure water) can be obtained by, for example, treating raw water or pretreated water with the primary pure water apparatus described below. As the water quality of the pure water, for example, a resistivity is equal to or more than 17 MΩ·cm, an iron concentration is 3 ng/L to 5 ng/L, and a silica concentration is 10 ng/L to 1000 ng/L.

Pure water is supplied to the non-regenerative mixed bed ion exchange resin device 12, in which cations and anions in the water are removed. The configuration of the non-regenerative mixed bed ion exchange resin device 12 includes, for example, a cylindrical sealed container, in which mixed bed ion exchange resins are filled. In the mixed bed ion exchange resins, generally, cation exchange resins and anion exchange resins are mixed. In the non-regenerative mixed bed ion exchange resin device 12, microparticles such as silica and iron, which easily form colloids, break through more easily compared with strong ions such as sodium and chlorine. In conventional methods, it is considered that these microparticles pass through the ultrafiltration membrane device 14 to increase the number of microparticles in ultrapure water. In accordance with the secondary pure water apparatus 10 of the present embodiment, by controlling the ultrafiltration membrane device 14 under the conditions described below, it is possible to suppress these microparticles from passing through the ultrafiltration membrane device 14. Although iron, silica, or the like may be present in either form of ions, colloid, or microparticles in water, in this specification, they are herein recited as microparticles without particularly regarding the form in water.

The pure water that has passed through the non-regenerative mixed bed ion exchange resin device 12 is then supplied to the ultrafiltration membrane device 14 by the booster pump 13 with addition of water supply pressure. In the method for producing ultrapure water of the present embodiment, filtration is performed in the ultrafiltration membrane module of the ultrafiltration membrane device 14 under conditions satisfying both (1) and (2) below.
(1) A permeate water flux at the time of filtration is within the range from equal to or more than 0.5 times to equal to or less than 2.0 times of an optimum permeate water flux determined according to intermembrane differential pressure/permeate water flux in the filtration membrane.
(2) A water recovery rate in the filtration is equal to or more than 50% and less than 80%.

The above conditions (1) and (2) are described in detail below. At first, “optimum permeate water flux determined according to intermembrane differential pressure/permeate water flux in the filtration membrane” in the above condition (1) is described. When the pressure of water supplied to the filtration membrane is constant, the intermembrane differential pressure at the time of filtration is proportional to a thickness of the filtration membrane, and the permeate water flux is inversely proportional to the thickness of the filtration membrane. Accordingly, when the “intermembrane differential pressure/permeate water flux” (hereinafter, referred to as “K value”) is calculated when water is made to flow through the filtration membrane under certain conditions, “K value” is obtained as a value intrinsic to the filtration membrane regardless of water flow conditions through the filtration membrane. Note that “K value” herein is represented as a value of “intermembrane differential pressure (Kgf/m²)/permeate water flux (m/h)”×10⁻⁴, that is, a value of “intermembrane differential pressure (Kgf/cm²)/permeate water flux (m/h).”

The water flow conditions of the ultrafiltration membrane device 14 in the above (1) is, in view of improving the removal rate of microparticles, equal to or more than 0.5 times and equal to or less than 2.0 times, preferably equal to or more than 0.7 times and equal to or less than 1.6 times, and more preferably equal to or more than 0.8 times and equal to or less than 1.2 times of the optimum permeate water flux determined according to the K value.

The optimum permeate water flux is determined in accordance with the following formula (3) according to the K value.

$$Optimum permeate water flux = - 0.69 {log}_{10} ( K ) + 0.64 \qquad ( 3 )$$

The present inventors made various preliminary experiments, and found that the optimum permeate water flux can be obtained by the above formula (3). The preliminary experiments were performed as follows. At first, commercially available ultrafiltration membrane modules (nominal molecular weight cut-offs of 4000, 6000, and 10000), microfiltration membrane module, and ion exchange membrane module for a secondary pure water apparatus were obtained, and the permeate water flux in each membrane module was measured when the intermembrane differential pressure was changed. From the measurement results, “intermembrane differential pressure/permeate water flux,” i.e., the K value, at each intermembrane differential pressure was calculated. Herein, it was confirmed that the K values were approximately constant regardless of the intermembrane differential pressure or water recovery rate. In the preliminary experiments, the intermembrane differential pressure was changed in two to five ways to obtain the K values for each condition, and the K value was determined by the arithmetic means. From the “experiment to determine K value (Table 2)” described below, it was found that the K values were approximately constant regardless of condition. This is consistent with the fact that it is possible to derive, from Darcy's law, that the K value is the same dimensional parameter as the membrane thickness.

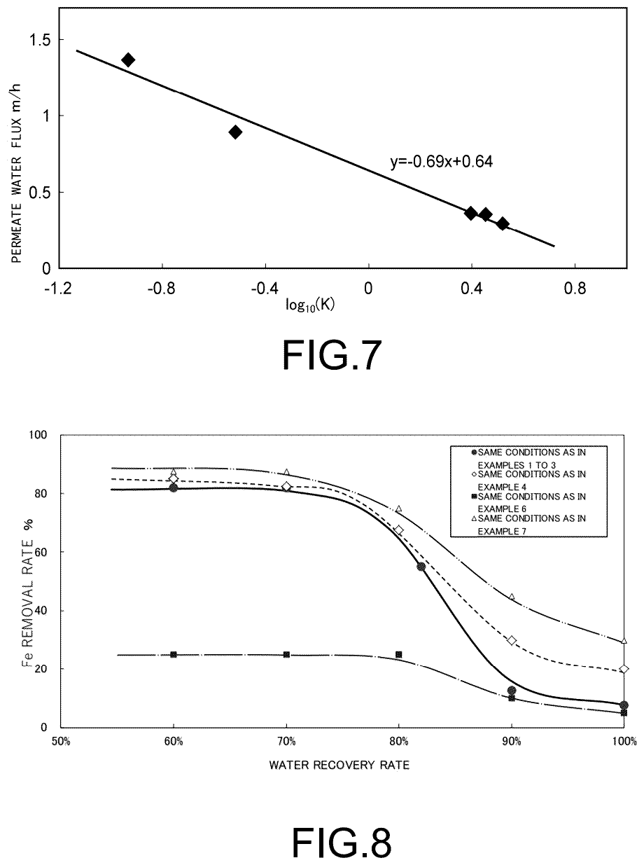

Next, by referring to the “recommended operating conditions” or “standard operating conditions” described in the user manual or the like of the commercially available membrane modules, and using the “recommended filtered water amount (permeate water amount)” indicated as the maximum filtered water amount (maximum permeate water amount) or the like when operated under the above operating conditions, the filtration flux (permeate water flux), that is, the value of filtered water amount (permeate water amount) divided by the membrane area was set as the vertical axis, and the K value was set as the horizontal axis to plot the values. Then, the graph of FIG. 7 and the above formula (3) were obtained by an automatic program using a least-squares method. The “recommended operating conditions” or “standard operating conditions” is generally defined by distributors as conditions under which a membrane module for the end of an ultrapure water apparatus can be operated without clogging or damage. Many preliminary experiments have confirmed that the same trend as the above formula (3) is observed in membranes other than those used in the “experiment to determine K values (Table 2)” described below.

In the following, the above condition (2) is described. With a state satisfying the above condition (1), by adopting the above condition “(2) a water recovery rate in the filtration equal to or more than 50% and less than 80%,” microparticles can be removed at high accuracy in the ultrafiltration membrane device 14. This is considered to be because, as described below, it is possible to restrain passage of microparticles smaller than the pore size of an ultrafiltration membrane through the ultrafiltration membrane, and thus a high removal rate can be maintained.

Conventionally, in a filtration membrane device such as an ultrafiltration membrane device, it has been considered that: microparticles larger than the pore size of an ultrafiltration membrane are trapped by the membrane, so that the microparticles are removed from water; that is, filtration proceeds mainly by the surface filtration mechanism. Therefore, a deposition layer (cake) of microparticles is formed on the surface of the ultrafiltration membrane as the treatment period elapses, and this microparticle-deposited layer traps the microparticles. Thus, it was also considered that the formation of the deposition layer improves the removal rate of microparticles. Accordingly, the ultrafiltration membrane device at the end of the secondary pure water apparatus has conventionally adopted a method of either narrowing down the amount of concentrated water to increase the water recovery rate, or conducting total filtration, in order to reduce the number of microparticles in ultrapure water (for example, refer to Patent Literature 1, and paragraph 0018 of Patent Literature 2).

However, as a result of consideration, the present inventors hypothesized that: microparticles such as silica and iron observed in terminal ultrapure water are so-called colloidal; the microparticles may be smaller than the pore size of the ultrafiltration membrane; thereby filtration of the microparticles proceeds by the mechanism of deep bed filtration rather than the surface filtration mechanism as described above; and formation of a deposition layer may not progress so much because the number of microparticles in the water is small. Then, they performed experiments. As a result, they found that the removal rate of microparticles through a filtration membrane can be enhanced by using a cross-flow system and performing filtration under the conditions described above. The reason for that is not necessarily obvious, but may be considered as follows.

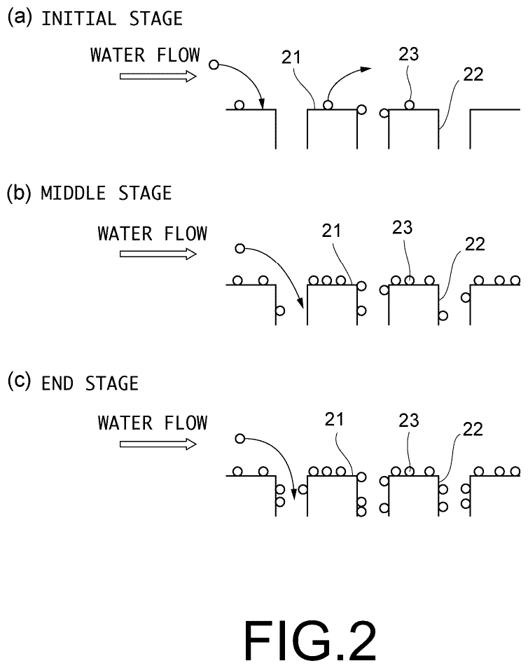

FIG. 2 is a diagram for describing states of microparticles trapped on a membrane in membrane filtration of the present embodiment: showing, from the above, (a) initial stage of filtration, (b) stage at which the filtration proceeds (middle stage), and (c) stage at which the filtration further proceeds (end stage).

In FIG. 2, rectangles represent filtration membrane surfaces 21 and pore inner walls 22, and small circles represent microparticles 23. In FIG. 2, thick arrows represent water flow, and thin arrows represent movement of the microparticles 23. In membrane filtration, there are two possible places where the microparticles 23 are trapped and adsorbed; the membrane surfaces 21 and the pore inner walls 22. When the filtration membrane is new or nearly new, the number of the microparticles 23 already adsorbed to the filtration membrane surfaces 21 or pore inner walls 22 of is small. Therefore, both the membrane surfaces 21 and pore inner walls 22 can adsorb the microparticles 23. Provided that water to be treated contacts with the membrane surfaces 21 first, and thus the membrane surfaces 21 mainly adsorb the microparticles 23 as shown in FIG. 2(a). Thereafter, when adsorption of the microparticles 23 on the membrane surfaces 21 proceeds, adsorption of the microparticles 23 on the pore inner walls 22 gradually proceeds, as shown in FIG. 2(b).

When the membrane filtration is further proceeded, and adsorption of the microparticles 23 to the ultrafiltration membrane proceeds, the number of the microparticles 23 adsorbed to the membrane surfaces 21 or pore inner walls 22 increases. Thereby, the microparticles 23 are hardly adsorbed on the membrane newly, the microparticles 23 pass through the membrane, as shown in FIG. 2(c). That is, the removal rate of the microparticles 23 decreases.

The microparticles 23 adsorbed on the membrane are repeatedly adsorbed and desorbed in the process of membrane filtration. Thus, by using cross flow membrane filtration, and increasing the flow velocity of water along the membrane surfaces 21 to suppress increase of the concentration of the microparticle 23 on the membrane surfaces 21, it is possible to maintain the initial state of membrane as shown in FIG. 2(a). Thereby, it is considered that passage of microparticles smaller than the pore size of the ultrafiltration membrane can be restrained, and thus a high removal rate can be maintained. Here, by increasing the flow velocity at the concentration side, that is, by decreasing the water recovery rate, the flow velocity along the membrane surface can be increased.

In the optimum permeate water flux determined according to the K value, when the water recovery rate in the ultrafiltration membrane device 14 (ultrafiltration membrane module) is equal to or more than 80%, microparticles cannot be sufficiently removed in the ultrafiltration membrane device 14. This is considered to be because the concentrated water amount is small, the flow velocity on the membrane surface becomes small, and thus microparticles smaller than the pore size of the ultrafiltration membrane pass through the ultrafiltration membrane. When the water recovery rate is less than 50%, the water recovery rate is too small, leading to the reduction of practicability. In view of improving the removal rate of microparticles to efficiently obtain ultrapure water, the water recovery rate in the ultrafiltration membrane device 14 is preferably equal to or more than 60% and equal to or less than 70% in the optimum permeate flux obtained according to the K value.

As described above, one or more selected from a microfiltration membrane device and an ion exchange membrane device may be used in place of the ultrafiltration membrane device 14. In this case, one selected from the ultrafiltration membrane device, microfiltration membrane device, and ion exchange membrane device may be used alone, or two or more of them may be used in combination. A plurality of the ultrafiltration membrane devices, microfiltration membrane devices, and ion exchange membrane devices may be used, respectively. The ultrafiltration membrane device 14 and the ion exchange membrane device provided on the water feed pipe 1a may be used in combination.

The ultrafiltration membrane device 14 removes microparticles in water, for example, microparticles with equal to or more than 50 nm particle diameter (preferably equal to or more than 10 nm). The ultrafiltration membrane device is constituted of one or more ultrafiltration membrane modules. The species of the ultrafiltration membrane included in the ultrafiltration membrane module is not particularly limited, and is typically a hollow fiber membrane, or may also be a spiral membrane, tubular membrane, flat membrane, and the like. The material of the ultrafiltration membrane is polysulfone, polyvinylidene fluoride, polyethylene, polypropylene, or the like, and preferably has a nominal molecular weight cut-off of 3000 to 8000, more preferably 4000 to 6000. Either the internal pressure type or external pressure type ultrafiltration membrane module may be used.

The microfiltration membrane (MF) device is constituted of one or more microfiltration membrane (MF) cartridges. The microfiltration membrane (MF) cartridge includes a microfiltration membrane (MF). The material of the microfiltration membrane is polysulfone, polyether sulfone, polyvinylidene fluoride, polyethylene, polypropylene, polytetrafluoroethylene, or the like. A nominal pore diameter of the microfiltration membrane is, for example, 0.5 nm to 5 μm.

The ion exchange membrane device is constituted of one or more ion exchange membrane cartridges. The ion exchange membrane cartridge includes an ion exchange membrane, and the ion exchange membrane may be any of a cation exchange membrane, an anion exchange membrane, or a bipolar membrane, which is a composite of a cation exchange membrane and an anion exchange membrane.

In FIG. 1, the valve V1a and the valve V1b are, for example, opening/closing valves or opening variable valves. The water recovery rate in the ultrafiltration membrane device 14 can be adjusted by opening and closing, or adjusting opening of the valve V1a and the valve V1b. The valve V1a and the valve V1b may be configured with valves capable of automatic control, and the secondary pure water apparatus 10 may be provided with a control device. Thus, the valve V1a and the valve V1b may be controlled automatically by the above control device such that the water recovery rate of the ultrafiltration membrane device 14 satisfies the above condition (2). Note that the valve V1a is provided at the downstream side of the branch point to the point of use 15 of the circulation pipe 1c for obtaining sufficient water supply pressure to the point of use 15. However, the valve V1a may be provided between the ultrafiltration membrane device 14 and the branch point to the point of use 15.

The booster pump 13 is a general booster pump, and the configuration is not particularly limited. For example, even when a part contacting with pure water is formed of a material such as stainless steel from which trace metal components such as iron and chromium are eluted, eluted metal components are removed by the ultrafiltration membrane device 14 in the present embodiment. Thus, the material of the part contacting with primary pure water in the booster pump 13 has little effect on the water quality of produced ultrapure water. Accordingly, booster pumps generally used in production of pure water may be used as the booster pump 13. When the water feed pump P is provided between the pure water tank 11 and the non-regenerative mixed bed ion exchange resin device 12, a trace amount of metal may be generated from the pump, but a large part of the trace amount of metal is adsorbed and removed by the ion exchange resin in the non-regenerative mixed bed ion exchange resin device 12. The control device may control the water feed pump P and booster pump 13 such that the permeate water flux of the ultrafiltration membrane device 14 satisfies the above condition (1).

In the secondary pure water apparatus 10 of the present embodiment, by providing the booster pump 13 between the non-regenerative mixed bed ion exchange resin device 12 and the ultrafiltration membrane device 14, water feeding pressure to the point of use 15 can be increased. In the booster pump 13, the part contacting with water to be treated may be formed of a material from which a metal component is not eluted, or is hardly eluted. The booster pump 13 may be provided at the preceding stage of the non-regenerative mixed bed ion exchange resin device 12.

The water quality of ultrapure water obtained through the ultrafiltration membrane device 14 is, for example, such that the number of microparticles with equal to or more than 50 nm particle diameter is equal to or less than 50 pcs./L, the total organic carbon (TOC) concentration is equal to or less than 1 μgC/L, and the resistivity is equal to or more than 18 MΩ·cm. Ultrapure water having the iron concentration equal to or less than 1 ng/L and preferably equal to or less than 0.1 ng/L, and the silica concentration equal to or less than 20 ng/L and preferably equal to or less than 10 ng/L may be obtained.

### Variant Example 1

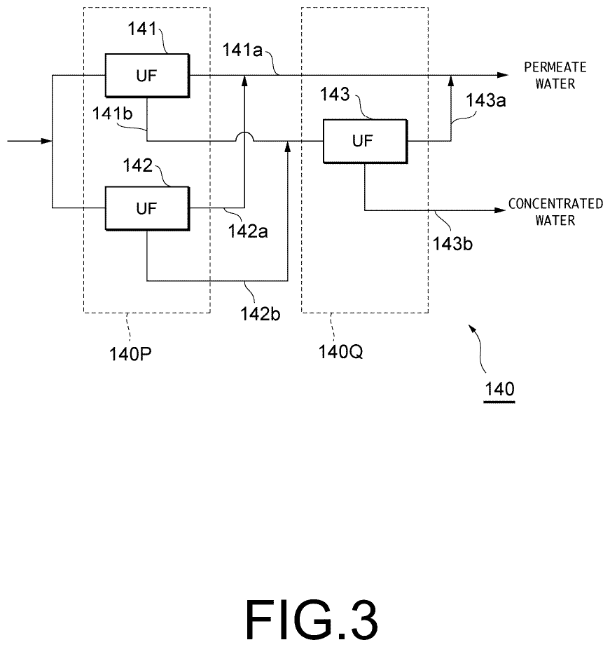

In the following, a first variant example of the secondary pure water apparatus 10 of the embodiment is described. FIG. 3 is a diagram schematically showing the configuration of the filtration membrane device 140 in the secondary pure water apparatus of the first variant example. In the filtration membrane device 140 of the first variant example includes three or more ultrafiltration membrane modules constituted as an array as the ultrafiltration membrane device 14 in the secondary pure water apparatus 10 of FIG. 1. The other configurations are the same as the secondary pure water apparatus 10 according to the embodiment described above. Also in this variant example, one or more of a microfiltration membrane and an ion exchange membrane may be used in place of the ultrafiltration membrane.

As shown in FIG. 3, the filtration membrane device 140 includes two banks; a first bank 140P and a second bank 140Q. The first bank 140P and the second bank 140Q are arranged in series along the flow direction.

The first bank 140P includes two ultrafiltration membrane modules; a first filtration membrane module 141 and a second filtration membrane module 142. The first filtration membrane module 141 and the second filtration membrane module 142 are arranged in parallel to the flow direction. The second bank 140Q includes a third filtration membrane module 143.

To the first filtration membrane module 141, a water feed pipe 141a for feeding permeate water and a drain pipe 141b for discharging concentrated water, from the first filtration membrane module 141, are connected. To a second filtration membrane module 142, a water feed pipe 142a for feeding permeate water and a drain pipe 142b for discharging concentrated water, from the second filtration membrane module 142, are connected. To a third filtration membrane module 143, a water feed pipe 143a for feeding permeate water and a drain pipe 143b for discharging concentrated water, from the third filtration membrane module 143, are connected. The drain pipe 141b and the drain pipe 142b are connected to the supply side of the third filtration membrane module 143.

By these configurations, pure water supplied to the first bank 140P is filtered through the first filtration membrane module 141 and the second filtration membrane module 142, and then permeate water from these modules is fed to the water feed pipes 141a and the water feed pipe 142a, respectively. The concentrated water from the first filtration membrane module 141 and the second filtration membrane module 142 is discharged from the drain pipe 141b and drain pipe 142b, respectively, and then supplied to the second bank 140Q.

The concentrated water from the first bank 140P supplied to the second bank 140Q is filtered through the third filtration membrane module 143, and then separated into permeate water and concentrated water. The permeate water from the third filtration membrane module 143 is fed to the water feed pipe 143a, and the concentrated water is discharged from the drain pipe 143b.

Operating conditions in the first filtration membrane module 141, the second filtration membrane module 142, and the third filtration membrane module 143 are all the same as the operating conditions in the ultrafiltration membrane device (ultrafiltration membrane module) in the secondary pure water apparatus 10 according to the embodiment described above. The first filtration membrane module 141, the second filtration membrane module 142, and the third filtration membrane module 143 are controlled so as to satisfy the following conditions (1) and (2) in the respective modules. This control can be achieved by controlling output of the pump that supplies water to the filtration membrane module, and providing opening variable valves to the water feed pipe and drain pipe, respectively, to adjust the flow rate by opening of the valves.
(1) A permeate water flux at the time of filtration is within the range from equal to or more than 0.5 times to equal to or less than 2.0 times of an optimum permeate water flux determined according to intermembrane differential pressure/permeate water flux in the filtration membrane.
(2) A water recovery rate in the filtration is equal to or more than 50% and less than 80%.

The permeate water from the first bank 140P and the second bank 140Q is supplied to the point of use via the water feed pipe 141a, the water feed pipe 142a, and the water feed pipe 143a. Concentrated water from the second bank 140Q may be discharged outside the system, or may be returned to one or two or more of the inlet side of the booster pump, the pure water tank, or the primary pure water apparatus provided at the upstream side of the secondary pure water apparatus and a further preceding stage thereof.

Herein, the example having two banks, in which two filtration membrane modules are included at the most upstream side is described. However, the filtration membrane device may have three or more banks, and each bank may include three or more filtration membrane modules. In this case, the three or more banks are arranged in series along the flow direction, and a plurality of filtration membrane modules in one bank are arranged in parallel to the flow direction. In addition, concentrated water from the bank at the preceding stage is collected and treated by the filtration membrane module in the bank at the subsequent stage. Thus, the amount of water treated in the bank becomes smaller toward the downstream side. Taking this into consideration, the number of filtration membrane modules at the subsequent stage can be determined in accordance with the water recovery rate in the filtration membrane module at the preceding stage.

When using the filtration membrane device 140 in which three or more filtration membrane modules are used to constitute an array as described above, the overall water recovery rate in the unit can be improved. For example, when the water recovery rate of the first filtration membrane module 141, the second filtration membrane module 142, and the third filtration membrane module 143 in the filtration membrane device 140 shown in FIG. 3 are all 50%, the filtration membrane device 140 as a whole can achieve the water recovery rate of 75%. Accordingly, both high water recovery rate and high microparticle removal rate can be achieved.

### Variant Example 2

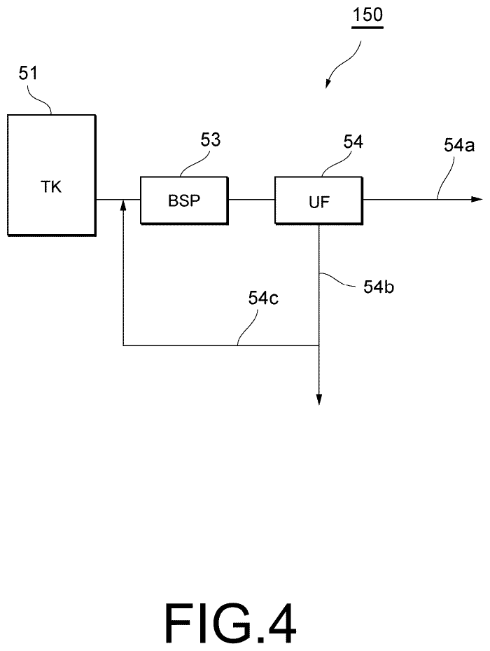

Next, a second variant example of the secondary pure water apparatus 10 of the embodiment is described. FIG. 4 is a block diagram schematically showing the configuration of the secondary pure water apparatus 150 of the second variant example. The secondary pure water apparatus 150 of the second variant example is different from the secondary pure water apparatus 10 of FIG. 1 in that it has a circulation pipe 54c that returns concentrated water from the ultrafiltration membrane device 14 to the inlet side of the booster pump 53. However, the other configurations are the same. The secondary pure water apparatus 150 of FIG. 4 includes a pure water tank 51, a booster pump 53, and an ultrafiltration membrane device (UF) 54 in this order. In FIG. 4, description of the non-regenerative mixed bed ion exchange resin device, valves, point of use, and circulation pipe from the downstream of the point of use is omitted. However, these are included in the secondary pure water apparatus 150 similarly to the secondary pure water apparatus 10 of FIG. 1. Also in this variant example, one or more of a microfiltration membrane and an ion exchange membrane may be used in place of the ultrafiltration membrane.

A water feed pipe 54a is connected to the permeation side of the ultrafiltration membrane device 54, and permeate water is supplied to a point of use (not shown) via the water feed pipe 54a. A drain pipe 54b is connected to the concentration side of the ultrafiltration membrane device 54, and one end of the circulation pipe 54c is connected to the path of the drain pipe 54b. The other end of the circulation pipe 54c is connected to the inlet side of the booster pump 53. Thereby, part of concentrated water from the ultrafiltration membrane device 54 is returned to the booster pump 53. Valves may be provided in the drain pipe 54b, the downstream side from the circulation pipe 54c, and in the circulation pipe 54c, respectively, to control the flow rate from the drain pipe 54b to the circulation pipe 54c by the valves, and thereby circulating part of the concentrated water to the booster pump 53.

The operating conditions of the ultrafiltration membrane device 54 are the same as those of the secondary pure water apparatus 10 of the embodiment described above. The ultrafiltration membrane device 54 includes an ultrafiltration membrane module, and the water flow conditions are controlled so that filtration in the above membrane module satisfies the following conditions (1) and (2). This control can be achieved by output control of the booster pump, and providing opening variable valves to the water feed pipe and the drain pipe, respectively, to adjust the flow rate by opening of the valves.
(1) A permeate water flux at the time of filtration is within the range from equal to or more than 0.5 times to equal to or less than 2.0 times of an optimum permeate water flux determined according to intermembrane differential pressure/permeate water flux in the filtration membrane.
(2) A water recovery rate in the filtration is equal to or more than 50% and less than 80%.

As described above, according to the secondary pure water apparatus 150 that circulates concentrated water from the ultrafiltration membrane device 54 to the inlet side of the booster pump, the flow rate of the drain pipe 54b can be increased while maintaining the flow rate of the water feed pipe 54a by using the circulation pipe 54c. Thus, the overall water recovery rate of the secondary pure water apparatus can be improved. In addition, the water recovery rate in the ultrafiltration membrane device 54 (filtration membrane module) can be reduced, and thus the removal rate of microparticles in the filtration membrane device 54 can be maintained high.

### Ultrapure Water Production System

Next, the ultrapure water production system and the method for producing ultrapure water according to the present embodiment are described.

The ultrapure water production system according to the present embodiment includes a primary pure water apparatus for performing primary pure water treatment for producing primary pure water from raw water or pretreated water, and the secondary pure water apparatus described above.

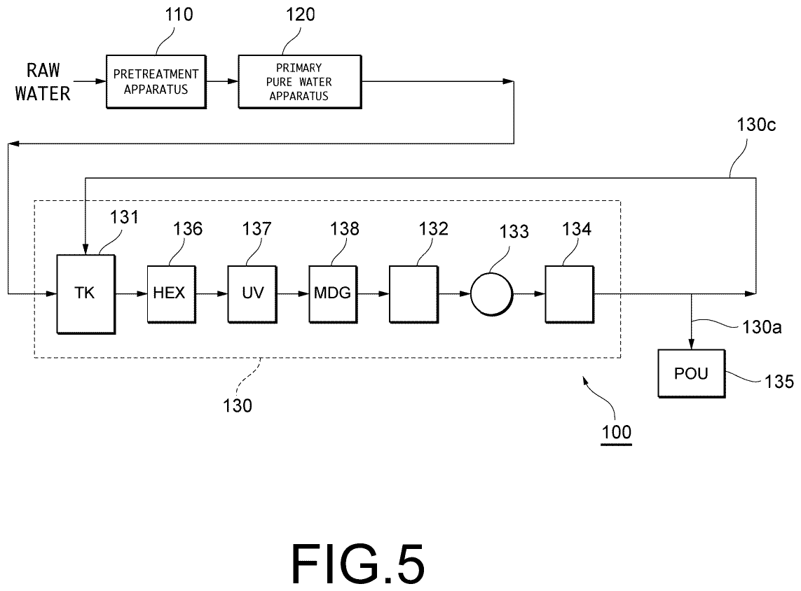

FIG. 5 is a block diagram schematically showing an ultrapure water production system 100 according to the present embodiment. The ultrapure water production system 100 includes a pretreatment apparatus 110, a primary pure water apparatus 120, and a secondary pure water apparatus 130. The secondary pure water apparatus 130 is different from the secondary pure water apparatus 10 of the embodiment described above in that it further has a heat exchanger 136, an ultraviolet ray irradiation device 137, and a membrane deaeration device 138. However, the other configurations are the same. Specifically, the secondary pure water apparatus 130 includes a pure water tank 131, a water feed pump (not shown), a heat exchanger (HEX) 136, an ultraviolet ray irradiation device (UV) 137, a membrane deaeration device 138, a non-regenerative mixed bed ion exchange resin device (Polisher) 132, a booster pump 133, and an ultrafiltration membrane (UF) device 134 in this order.

### Pretreatment Apparatus

Raw water is supplied to the pretreatment apparatus 110. The pretreatment apparatus 110 includes a flocculating and settling device, a sand filter, a membrane filtration device, and the like. By these devices, raw water is clarified, thereby producing pretreated water in which part of suspended substances and organic materials have been removed. As raw water, industrial water, tap water, ground water, river water, and the like may be used. In addition, if a urea removal device constituted of a combination of a high-pressure reverse osmosis membrane (RO) device, hypobromite addition, an ultraviolet ray irradiation device, and the like, or a high-pressure reverse osmosis membrane (RO) device and a boron removal device such as a boron selective ion-exchange device, and the like, are added to the pretreatment apparatus 110, brackish water or waste water may also be used as raw water. As raw water, one of them may be used alone, or two or more of them may be used in combination.

### Primary Pure Water Apparatus

The primary pure water apparatus 120 produces primary pure water by cleaning pretreated water to remove impurities from the pretreated water. Specifically, the primary pure water apparatus 120 includes various devices such as: a demineralizer for removing impurity ions; a reverse osmosis membrane device for removing inorganic ions, organic materials, and microparticles; a vacuum deaeration device for removing dissolved gas such as dissolved oxygen or a membrane deaeration device; a regenerative mixed bed demineralizer for removing remaining ions or the like; and an electric deionization device.

### Pure Water Tank

The primary pure water obtained by the primary pure water apparatus 120 is fed to the pure water tank 131. The pure water tank 131 temporarily stores the primary pure water obtained by the primary pure water apparatus 120. A preferred configuration of the pure water tank 131 is the same as the pure water tank 11 in the secondary pure water apparatus 10 according to the embodiment described above.

### Heat Exchanger

The heat exchanger 136 adjusts the temperature of the primary pure water by heat exchange (heating or cooling). Examples of the heat exchanger 136 include, but are not limited to, a plate type heat exchanger. The specific configuration of the heat exchanger is not particularly limited. Generally, the heat exchanger adjusts water temperature to a normal temperature, for example, approximately 20° C. However, the temperature may be adjusted to, for example, 60° C. to 80° C. In this case, the produced ultrapure water is called hot ultrapure water. When hot ultrapure water is produced, a heat exchanger may further be provided in addition to the heat exchanger 136. In that case, the above heat exchanger is provided, for example, between the non-regenerative mixed bed ion exchange resin device 132 and the ultrafiltration membrane device 134.

### Ultraviolet Ray Irradiation Device

The primary pure water, the temperature of which has been adjusted by the heat exchanger 136, is supplied to the ultraviolet ray irradiation device 137. The ultraviolet ray irradiation device 137 irradiates an ultraviolet ray to the primary pure water, thereby decomposing organic materials, performing bacteria-killing treatment (sterilization), or the like in the primary pure water. The ultraviolet ray irradiation device 137 includes, for example, an ultraviolet lamp capable of irradiating ultraviolet rays of wavelength around 185 nm or around 254 nm, and thereby can surely decompose organic materials or sterilize the primary pure water. The ultraviolet lamp of the ultraviolet ray irradiation device 137 is not particularly limited, and a low-pressure mercury lamp is preferred in view of ease of handling. Examples of the ultraviolet ray irradiation device 137 include a flow-through type in which ultraviolet lamps are arranged inside the housing along a channel of water to be treated, or an immersion type in which ultraviolet lamps are immersed in a tank for storing water to be treated. The flow-through type is preferred in view of processing efficiency.

### Membrane Deaeration Device

The membrane deaeration device 138 removes gas in the primary pure water, particularly dissolved oxygen, using a gas separation membrane that does not transmit moisture but transmit gas.

### Non-Regenerative Mixed Bed Ion Exchange Resin Device

The primary pure water from which dissolved oxygen has been removed by the membrane deaeration device 138 is fed to the non-regenerative mixed bed ion exchange resin device 132. The non-regenerative mixed bed ion exchange resin device 132 has the same configuration as the non-regenerative mixed bed ion exchange resin device 12 in the secondary pure water apparatus 10 according to the embodiment described above, and adsorb and remove organic acids generated by decomposition of organic materials with the ultraviolet ray irradiation device 137, or impurity ions such as metal ions remaining in water.

### Booster Pump

The booster pump 133 has the same configuration as the booster pump 13 in the secondary pure water apparatus 10 according to the embodiment described above. The booster pump 133 raises the water supply pressure of primary pure water in the pure water tank 131, thereby feeding the water to the ultrafiltration membrane device 134.

### Ultrafiltration Membrane Device

The pure water from which impurity ions have been removed by the non-regenerative mixed bed ion exchange resin device 132 is supplied to the ultrafiltration membrane device 134. The ultrafiltration membrane device 134 has the same configuration as the ultrafiltration membrane device 14 in the secondary pure water apparatus 10 according to the embodiment described above, and produces ultrapure water by removing microparticles. In the ultrapure water production system 100 of the present embodiment, the ultrafiltration membrane device 134 is arranged at the end of the secondary pure water apparatus 130, that is, at the side nearest to POU 135 in the secondary pure water apparatus 130. Also in the ultrapure water production system 100 of the present embodiment, one or more of a microfiltration membrane device and an ion exchange membrane device may be used in place of the ultrafiltration membrane device.

In the secondary pure water apparatus 130, for removing hydrogen peroxide secondarily generated by the ultraviolet ray irradiation device 137, for example, other treatment devices such as a column packed with a catalyst resin may be provided as necessary, to obtain ultrapure water with desired purity.

In the secondary pure water apparatus 130 of the present embodiment, by providing the booster pump 133 between the non-regenerative mixed bed ion exchange resin device 132 and the ultrafiltration membrane device 134, water feeding pressure to the ultrafiltration membrane device 134 can be increased. Although it can be considered that contact between the booster pump and water to be treated may increase the metal concentration in the water to be treated due to elution of metal components, by using the method according to the embodiment, metal components increased by elution can be removed by the filtration membrane device 134.

Secondary pure water (ultrapure water) obtained by the secondary pure water apparatus 130 through the above respective devices (respective steps) is delivered by the water feed pipe 130a to the usage place (point of use) 135 such as a process point in semiconductor manufacturing processes, for example. Among the delivered ultrapure water, ultrapure water that has not been used is circulated to the pure water tank 131 via a circulation pipe 130c, and stored in the pure water tank 131 with the primary pure water.

According to the ultrapure water production system 100, ultrapure water with an iron content of equal to or less than 1 ng/L and a silica concentration equal to or less than 20 ng/L may be obtained, and even ultrapure water with an iron concentration equal to or less than 0.1 ng/L and a silica concentration equal to or less than 10 ng/L may be obtained. Thus, in particular, the ultrapure water production system 100 can be suitably used for producing ultrapure water that is supplied to a process point in semiconductor manufacturing processes.

### Example

Next, Examples will be described. The present invention is not limited to the Examples below.

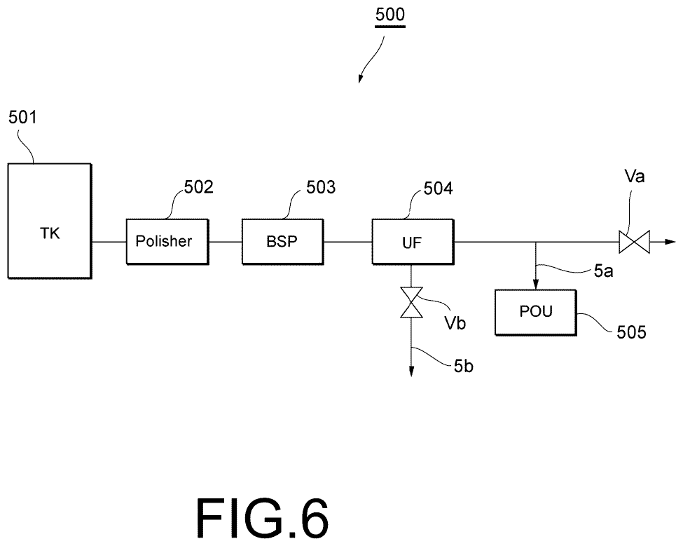

The configuration of the secondary pure water apparatus 500 used in Example 1 is schematically shown in FIG. 6. The secondary pure water apparatus 500 shown in FIG. 6 includes a pure water tank (TK) 501, a non-regenerative mixed bed ion exchange resin device (Polisher) 502, a booster pump (BSP) 503, a water feed pump (not shown), and an ultrafiltration membrane module (UF) 504 in this order. The permeation side of the ultrafiltration membrane module 504 is connected to a point of use (POU) 505 via a water feed pipe 5a having a branch, and a valve Va is provided in the downstream path of the point of use of the water feed pipe 5a. A drain pipe 5b is connected to the concentration side of the ultrafiltration membrane module 504, and a valve Vb is provided in the path of the drain pipe 5b.

In Examples 2 to 5 and Comparative Examples 1 to 3, a branch pipe was provided between the booster pump (BSP) 503 and the ultrafiltration membrane module (UF) 504. In the path of the branch pipe, filter devices described in Table 1, that is, an ultrafiltration membrane module (UF), a microfiltration membrane module (MF), and an ion exchange membrane module are arranged, respectively. Thus, the ultrafiltration membrane module 504 of Example 1 was changed to the filter devices described in Table 1, respectively, and thereby performing tests.

From the pure water tank 501, by a water feed pump (not shown) provided at the subsequent stage of the pure water tank 501, pure water was made to flow through the non-regenerative mixed bed ion exchange resin device 502, the booster pump 503, and the ultrafiltration membrane module 504 in this order. At this time, output of the booster pump 503 was adjusted such that the permeate water flux (flux) of the ultrafiltration membrane module 504 became the “flux/optimum permeate water flux” values described in Table 1. Furthermore, flow rates of concentrated water and permeate water were adjusted with the valve Va and the valve Vb, thereby adjusting the water recovery rate in the ultrafiltration membrane module 504 as described in Table 1. Examples of using the microfiltration membrane module or the ion exchange membrane module are the same.

In Example 1, treated water (permeate water) of the ultrafiltration membrane module 504 was collected to measure iron (Fe) concentration and silica concentration. In other Examples and Comparative Examples, treated water (permeate water) of each filter device was collected to measure the iron (Fe) concentration and silica concentration. Thus, the respective removal rates were determined. In both Examples and Comparative Examples, the measurements were performed at the initial stage of water flow and after 60 days from the start of water flow. The results are shown in Table 1.

The specifications or the like of the filter devices used in Examples and Comparative Examples were as follows.

Ultrafiltration membrane module (UF, nominal molecular weight cut-off 6000): OLT6036 (product of Asahi Kasei Corporation), polysulfone hollow fiber membrane, membrane area 34 mm², one module
Ultrafiltration membrane module (UF, nominal molecular weight cut-off 4000): OLT6036 (product of Asahi Kasei Corporation.), polysulfone hollow fiber membrane, membrane area 34 mm², one module
Ultrafiltration membrane module (UF, nominal molecular weight cut-off 10000): OLT3026 (product of Asahi Kasei Corporation), polysulfone hollow fiber membrane, membrane area 10.7 mm², one module
Microfiltration membrane module (MF): TRINZIK (Entegris Japan Co., Ltd.) 15 nm, hydrophilic PTFE membrane, 10-inch module, membrane area 1.1 mm², one module
Ion exchange membrane module: PROTEGO PLUS (Entegris Japan Co., Ltd.), pore diameter 20 nm, with cation exchangeability, made of hydrophilic polysulfone, 10-inch module, membrane area 0.54 mm², one module

In the respective filter devices, experiments to determine the K values were performed as follows. The intermembrane differential pressure was changed as shown in Table 2 to measure the permeate water flux at that time. From the measurement results, “intermembrane differential pressure/permeate water flux,” i.e., the K value at each intermembrane differential pressure was calculated. In the respective filter devices, the K values were obtained with two to five different intermembrane differential pressures. The results are shown in Table 2. From Table 2, it was confirmed that the K values were constant regardless of the intermembrane differential pressure or water recovery rate. In addition, the arithmetic means of the K values obtained in Table 2 was calculated for each filter device, and the optimum flux (optimum permeate water flux) was obtained using the above arithmetic mean values with the above formula (3) and the graph of FIG. 7. The optimum flux determined according to the K value is as follows.
Ultrafiltration membrane device (nominal molecular weight cut-off 6000): 0.33 m/h
Ultrafiltration membrane device (nominal molecular weight cut-off 4000): 0.28 m/h
Ultrafiltration membrane device (nominal molecular weight cut-off 10000): 0.37 m/h
Microfiltration membrane device: 0.99 m/h
Ion exchange membrane device: 1.28 m/h

Analysis methods in Examples and Comparative Examples are as follows.
Iron concentration: Sample water was concentrated by evaporation, and then analyzed by ICP-MS (inductively coupled plasma-mass spectroscopy).
Silica concentration: Sample water was concentrated by evaporation, and then analyzed by ICP-MS.

TABLE 1

| | | | | | Fe | | Si |
|---|---|---|---|---|---|---|---|
| | | FLUX/ | | | WATER | | WATER |
| | | OPTIMUM | PERMEATE | | QUALITY OF | | QUALITY OF |
| | | PERMEATE | WATER | WATER | TREATED | REMOVAL | TREATED |
| | FILTER | WATER | FLUX | RECOVERY | WATER | RATE | WATER |
| | SPECIES | FLUX | (m/h) | RATE | (ng/L) | (%) | (ng/L) |
| | — | — | — | — | 0.4 | — | 115 |
| EXAMPLE 1 | UF | 1.0 | 0.33 | 80% | ≤0.1 | 82 | 20 |
| (EXAMPLE) | (MOLECULAR | | | | | | |
| EXAMPLE 2 | WEIGHT CUT- | 1.0 | 0.33 | 70% | ≤0.1 | 82 | 20 |
| (EXAMPLE) | OFF 6000) | | | | | | |
| EXAMPLE 3 | | 1.0 | 0.33 | 82% | 0.18 | 55 | 40 |
| (COMPARATIVE | | | | | | | |
| EXAMPLE) | | | | | | | |
| EXAMPLE 4 | | 0.48 | 0.16 | 70% | ≤0.1 | 83 | |
| (COMPARATIVE | | | | | | | |
| EXAMPLE) | | | | | | | |
| EXAMPLE 5 | | 1.6 | 0.53 | 70% | 0.1 | 75 | |
| (EXAMPLE) | | | | | | | |
| EXAMPLE 6 | | 2.1 | 0.70 | 70% | 0.3 | 25 | |
| (COMPARATIVE | | | | | | | |
| EXAMPLE) | | | | | | | |
| EXAMPLE 7 | UF | 0.9 | 0.28 | 70% | ≤0.1 | 88 | 10 |
| (EXAMPLE) | (MOLECULAR | | | | | | |
| | WEIGHT CUT- | | | | | | |
| | OFF4000) | | | | | | |
| EXAMPLE 8 | MF | 1.0 | 0.99 | 70% | ≤0.1 | 75 | 20 |
| (EXAMPLE) | | | | | | | |
| EXAMPLE 9 | | 1.0 | 0.99 | 100% | 0.27 | 33 | |
| (COMPARATIVE | | | | | | | |
| EXAMPLE) | | | | | | | |
| EXAMPLE 10 | ION | 1.0 | 1.02 | 70% | ≤0.1 | 75 | 20 |
| (EXAMPLE) | EXCHANGE | | | | | | |
| EXAMPLE 11 | MEMBRANE | 1.0 | 1.02 | 100% | 0.2 | 50 | 45 |
| (COMPARATIVE | | | | | | | |
| EXAMPLE) | | | | | | | |

TABLE 2

| | INTERMEMBRANE | PERMEATE | K VALUE |
|---|---|---|---|
| | DIFFERENTIAL | WATER | (INTERMEMBRANE |
| | PRESSURE | FLUX | DIFFERENTIAL PRESSURE/ |
| FILTER SPECIES | (kgf/cm2) | (m/h) | PERMEATE WATER FLUX) |
| UF | 0.88 | 0.30 | 3.0 |
| (MOLECULAR WEIGHT | 0.73 | 0.22 | 3.3 |
| CUT-OFF 4000) | 0.54 | 0.18 | 3.0 |
| | 1.00 | 0.30 | 3.3 |
| | 0.50 | 0.16 | 3.2 |
| UF | 1.00 | 0.35 | 2.8 |
| (MOLECULAR WEIGHT | 0.70 | 0.25 | 2.8 |
| CUT-OFF 6000) | 0.37 | 0.13 | 2.9 |
| MF | 1.50 | 1.36 | 1.1 |
| | 0.75 | 0.73 | 1.0 |

In Table 1, the measurements were performed when 60 days have passed from the start of water flow. In Examples, the removal rate remained stable thereafter at least 30 days. On the contrary, in Comparative Examples, the removal rate tended to decrease gradually. FIG. 8 shows the water recovery rate and iron removal rate when the size of the permeate water flux (ratio relative to the optimum permeate water flux) at the time of treatment was changed in filter devices (modules) using the ultrafiltration membrane (UF) with 6000 or 4000 molecular weight cut-off. In the graph shown in FIG. 8, the same conditions of the optimum permeate water flux as in examples 1 to 3, 4, 6, and 7 were used. FIG. 8 shows that there is no significant change in the iron removal rate regardless of the water recovery rate when filtration was performed with permeate water flux greater than 2.0 times the optimum permeate water flux. When filtration is performed with a permeate water flux of less than 0.5 times the optimum permeate water flux, the water recovery rate of equal to or more than 50% and less than 80% improves the iron removal rate, but the permeate water flux is too small to be practical due to reduced water production.

In all conditions shown in Table 1, the iron removal rate was equal to or more than 78% in the initial stage of water flow. That is, it is found that a high removal rate may or may not be maintained, depending on the operating conditions. The case where a high removal rate cannot be maintained is presumed as follows: in the mechanism as shown in FIG. 2, the state of membrane is shifted from FIG. 2 (a) to (b), and then to (c) described above, thereby the removal rate is decreased. On the other hand, in Examples, the membrane is maintained in the state of FIG. 2(a). Thus, it may be considered that there is no reduction in the removal rate, or only a slight reduction.

From the above Examples and Comparative Examples, it is found that, in an ultrafiltration membrane device provided near the end of the secondary pure water apparatus, the concentration of fine particles, particularly silica and iron, in treated water can be stably and significantly reduced by controlling the filtration under conditions satisfying both (1) and (2) below.
(1) A permeate water flux at the time of filtration is within the range from equal to or more than 0.5 times to equal to or less than 2.0 times of an optimum permeate water flux determined according to intermembrane differential pressure/permeate water flux in the filtration membrane.
(2) A water recovery rate in the filtration is equal to or more than 50% and less than 80%.

### REFERENCE SIGNS LIST

10, 150, 500 . . . secondary pure water apparatus, 11, 51, 501 . . . pure water tank, 12, 502 . . . non-regenerative mixed bed ion exchange resin device (Polisher), 13, 53, 503 . . . booster pump, 14 . . . ultrafiltration membrane device, 54 . . . ultrafiltration membrane module, 504 . . . ultrafiltration membrane device, 15, 505 . . . usage place (point of use), V1a, Va, V1b, Vb . . . valve, 1a, 5a, 54a . . . water feed pipe, 1b, 5b, 54b . . . drain pipe, 1c, 54c . . . circulation pipe, 140 . . . filtration membrane device, 140P . . . first bank, 140Q . . . second bank, 141 . . . first filtration membrane module, 142 . . . second filtration membrane module, 143 . . . third filtration membrane module, 141a, 142a, 143a . . . water feed pipe, 141b, 142b, 143b . . . drain pipe, 100 . . . ultrapure water production system, 110 . . . pretreatment apparatus, 120 . . . primary pure water apparatus, 130 . . . secondary pure water apparatus, 131 . . . pure water tank, 132 . . . non-regenerative mixed bed ion exchange resin device (Polisher), 136 . . . heat exchanger, 137 . . . ultraviolet ray irradiation device, 138 . . . membrane deaeration device, 133 . . . booster pump, 134 . . . ultrafiltration membrane (UF) device, 135 . . . usage place (point of use), 130a . . . water feed pipe, 130c . . . circulation pipe

1. A method for producing ultrapure water treating raw water with a primary pure water apparatus and a secondary pure water apparatus in this order comprising:
performing a filtration through a filtration membrane at an end of the secondary pure water apparatus;
wherein the filtration membrane is one or more selected from an ultrafiltration membrane (UF), a micro membrane (MF), and an ion exchange membrane,
performing the filtration under a condition satisfying both (1) and (2) below:
(1) a permeate water flux at the time of filtration is within a range from equal to or more than 0.5 times to equal to or less than 2.0 times of an optimum permeate water flux determined according to intermembrane differential pressure/permeate water flux in the filtration membrane; and
(2) a water recovery rate in the filtration is equal to or more than 50% and less than 80%.

2. The method for producing ultrapure water according to claim 1, wherein water to be subjected to the filtration has a resistivity equal to or more than 17 MΩ·cm, an iron concentration of 3 ng/L to 100 ng/L, and a silica concentration of 10 to 1000 ng/L.

3. The method for producing ultrapure water according to claim 1, wherein treated water of a non-regenerative mixed bed ion exchange resin device is used as water to be subjected to the filtration.

4. (canceled)

5. The method for producing ultrapure water according to claim 1, wherein the ultrapure water produced by the method has an iron concentration equal to or less than 1 ng/L, and a silica concentration equal to or less than 20 ng/L.

6. An ultrapure water production apparatus having a primary pure water apparatus for producing primary pure water by treating raw water and a secondary pure water apparatus for treating the primary pure water,
the ultrapure water production apparatus comprising: a filtration membrane module having a filtration membrane at an end of the secondary pure water apparatus;
wherein the filtration membrane is one or more selected from an ultrafiltration membrane, a microfiltration membrane, and an ion exchange membrane,
and filtration in the filtration membrane module is controlled to a condition satisfying both (1) and (2) below:
(1) a permeate water flux of the filtration membrane module is within a range from equal to or more than 0.5 times to equal to or less than 2.0 times of an optimum permeate water flux determined according to intermembrane differential pressure/permeate water flux in the filtration membrane module; and
(2) a water recovery rate in the filtration membrane module is equal to or more than 50% and less than 80%.

7. The ultrapure water production apparatus according to claim 6, comprising a water feed pump, a non-regenerative mixed bed ion exchange resin device, and the ultrafiltration membrane module in this order.

8. The ultrapure water production apparatus according to claim 6, wherein water to be treated that is supplied to the filtration membrane module has a resistivity equal to or more than 17 MΩ·cm, an iron concentration equal to or more than 3 ng/L, and a silica concentration equal to or more than 100 ng/L.

9. (canceled)
